(19) United States
(12) Patent Application Publication
(10) Pub. No.: US 2015/0011189 A1
(43) Pub. Date: Jan. 8, 2015

(54) APPARATUS AND METHOD FOR CONTROLLING MULTI-USER PERMISSIONS IN TERMINAL

(71) Applicant: Samsung Electronics Co., Ltd., Suwon-si (KR)

(72) Inventors: Woo-Jin SHIN, Yongin-si (KR); Duk-Ki HONG, Suwon-si (KR)

(73) Assignee: Samsung Electronics Co., Ltd., Suwon-si (KR)

(21) Appl. No.: 14/271,833

(22) Filed: May 7, 2014

(30) Foreign Application Priority Data
Jul. 8, 2013 (KR) 10-2013-0079914

(51) Int. Cl. H04W 12/06; H04L 29/06

(52) U.S. Cl. CPC H04W 12/06; H04L 63/102
USPC 455/411

(57) ABSTRACT

An apparatus for controlling multi-user permissions in a terminal is provided. The apparatus includes a memory configured to store a permission setting value for a function based on subscription information of a main user, which is set in an account of each of at least one sub user, among the main user and the at least one sub user, who may use the terminal, and a controller configured to, if the terminal is logged in with an account of a specific sub user among the at least one sub user, perform a function based on the subscription information of the main user depending on the permission setting value which is set in the account of the specific sub user, with which the terminal is logged in.

### CROSS-REFERENCE TO RELATED APPLICATION(S)

This application claims the benefit under 35 U.S.C. §119(a) of a Korean patent application filed on Jul. 8, 2013 in the Korean Intellectual Property Office and assigned Serial No. 10-2013-0079914, the entire disclosure of which is hereby incorporated by reference.

### TECHNICAL FIELD

The present disclosure relates to an apparatus and method for controlling multi-user permissions in a terminal More particularly, the present disclosure relates to an apparatus and method for controlling permissions (or authorities) of multiple users of a terminal.

### BACKGROUND

The term ‘multi-user’ refers to a function of allowing more than one user, who are individually registered in one device, to individually set, decorate and use the device independently of other users. In recent years, the multi-user function has become popular.

However, although people have grown to expect the multi-user function to be provided mobile devices, the multi-user function is now supported only on the tablet computer models that have no telephony function (i.e., no modulator-demodulator (modem)).

Most mobile terminals equipped with the telephony function have a single Subscriber Identity Module (SIM) card having subscription information of the main user. In other words, the single SIM card has a personal phone number (or unique number) of the main user, and, based on the phone number, the terminal may operate privacy-oriented functions such as a call feature and a message feature, and a data service (or ‘data connecting’) function.

As for the functions (e.g., calling, messaging, a data service, and the like) used based on the phone number, the fee is determined depending on the usage of the functions. Therefore, there are many constraints in applying the existing multi-user concepts to these functions.

Moreover, if the phone number used as personal information of the main user is used by multiple users, the personal information of the main user may be leaked or otherwise used inappropriately. In other words, if a single phone number is used (or shared) by multiple users, the privacy of the main user may be violated.

Furthermore, if a call is sent using a phone number, a recipient (or callee) may identify the sender (or caller) based on the phone number based on a caller Identifier (ID). However, in the case where a single phone number is used, if multiple users use the phone number to send a call, the recipient may not clearly identify from whom the call has been received. So, the phone number may no longer serve as a private number or may result in confusion by the callee.

As a result, the recipient may misidentify the sender when he or she uses the phone number as personal information. Accordingly, there is a need for an improved apparatus and method for controlling multi-user permissions in a mobile terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for controlling multi-user permissions in a terminal.

Another aspect of the present disclosure is to provide an apparatus and method for controlling permissions of multiple users, for use of a terminal.

Another aspect of the present disclosure is to provide an apparatus and method for controlling permissions of sub users for a function that uses subscription information of a main user.

In accordance with an aspect of the present disclosure, an apparatus for controlling multi-user permissions in a terminal is provided. The apparatus includes a memory configured to store a permission setting value for a function based on subscription information of a main user, which is set in an account of each of at least one sub user, among the main user and the at least one sub user, who may use the terminal, and a controller configured to, if the terminal is logged in with an account of a specific sub user among the at least one sub user, perform a function based on the subscription information of the main user depending on the permission setting value which is set in the account of the specific sub user, with which the terminal is logged in.

In accordance with another aspect of the present disclosure, a method for controlling multi-user permissions in a terminal is provided. The method includes storing a permission setting value for a function based on subscription information of a main user, which is set in an account of each of at least one sub user, among the main user and the at least one sub user, who may use the terminal, and, if the terminal is logged in with an account of a specific sub user among the at least one sub user, performing a function based on the subscription information of the main user depending on the permission setting value which is set in the account of the specific sub user, with which the terminal is logged in.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a structure of a terminal according to an embodiment of the present disclosure;

FIG. 2A illustrates permission setting values for functions based on subscription information of the main user, which correspond to accounts of multiple sub users, which are stored in a memory of a terminal, according to an embodiment of the present disclosure;

FIG. 2B illustrates multiple processors of a controller in a terminal according to an embodiment of the present disclosure;

FIGS. 3A, 3B, and 3C are flowcharts illustrating control of a call sending operation in a sub user's account in a terminal according to an embodiment of the present disclosure;

FIGS. 4A, 4B, and 4C are flowcharts illustrating control of a call receiving operation in a sub user's account in a terminal according to an embodiment of the present disclosure;

FIGS. 5A, 5B, and 5C are flowcharts illustrating control of a message sending operation in a sub user's account in a terminal according to an embodiment of the present disclosure;

FIGS. 6A, 6B, and 6C are flowcharts illustrating control of a message receiving operation in a sub user's account in a terminal according to an embodiment of the present disclosure;

FIG. 7 is a flowchart illustrating an operation of notifying of the presence of a call or a message received in an account of a sub user whose permission is restricted, in a main user's account in a terminal according to an embodiment of the present disclosure; and

FIGS. 8A, 8B, and 8C are flowcharts illustrating control of a data service in a sub user's account in a terminal according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terminals, to which various embodiments of the present disclosure are applicable, may include mobile terminals and fixed terminals. The mobile terminals may include video phones, cellular phones, smart phones, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, e-Book readers, portable computers (laptop computers, tablet computers and the like), digital cameras, and the like. The fixed terminals may include desktop Personal Computers (PCs), and the like.

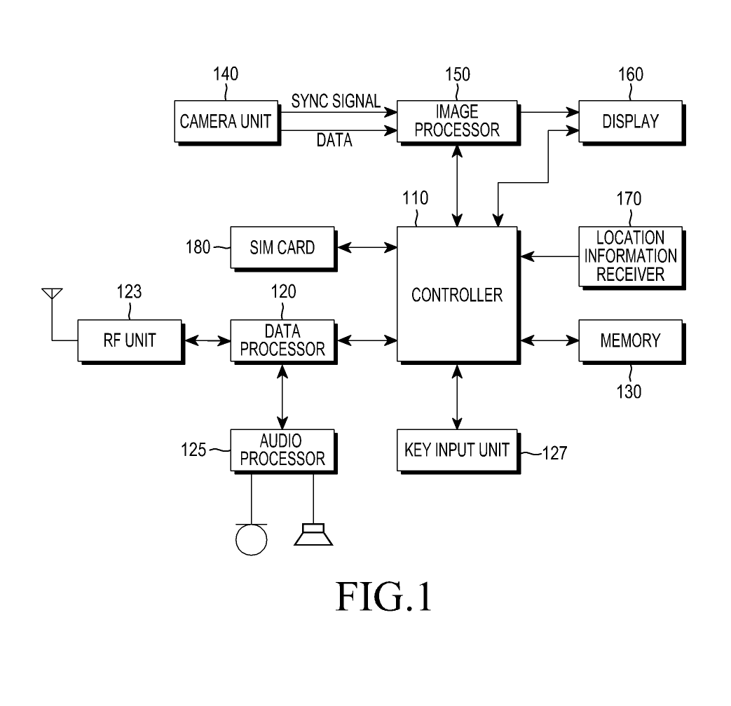

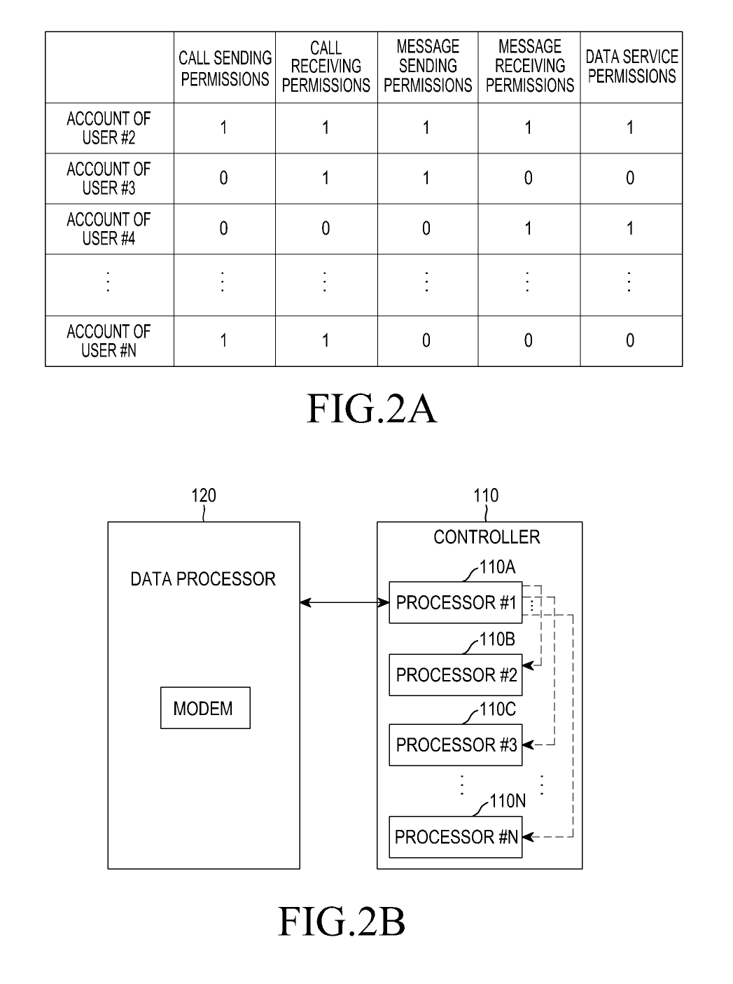

FIG. 1 illustrates a structure of a terminal according to an embodiment of the present disclosure. FIG. 2A illustrates permission setting values for functions based on subscription information of the main user, which correspond to accounts of multiple sub users, which are stored in a memory of a terminal, according to an embodiment of the present disclosure. FIG. 2B illustrates multiple processors of a controller in a terminal according to an embodiment of the present disclosure.

Referring to FIG. 1, a Radio Frequency (RF) unit 123 is responsible for wireless communication of the terminal. The RF unit 123 may include an RF transmitter for up-converting a frequency of transmission signals and amplifying the up-converted transmission signals, and an RF receiver for low-noise-amplifying received signals and down-converting a frequency of the amplified received signals. A data processor 120 may include a transmitter for coding and modulating the transmission signals, and a receiver for demodulating and decoding the received signals. In other words, the data processor 120 may be comprised of a modulator-demodulator (modem) and a coder-decoder (codec). The codec may include a data codec for processing packet data and the like, and an audio codec for processing audio signals such as voice. An audio processor 125 may play received audio signals output from the audio codec in the data processor 120, using a speaker, or may transfer transmission audio signals picked up by a microphone to the audio codec in the data processor 120.

A key input unit 127 may include character/numeric keys for entering character/numeric information, and function keys for setting a variety of functions.

A memory 130 may be comprised of a program memory and a data memory. The program memory may store programs for controlling the overall operation of the terminal, and programs for controlling the terminal to use the function based on subscription information of a main user, in an account of at least one sub user, depending on the permissions which are set in advance by the main user. The data memory may temporarily store the data generated during execution of the programs.

In accordance with various embodiments of the present disclosure, the memory 130 may store permission setting values for functions based on subscription information of the main user, which are set in accounts of sub users, among the main user and at least one sub user capable of using the terminal. The functions based on subscription information of the main user are functions that use a phone number of a Subscriber Identity Module (SIM) card, and may include call sending, call receiving, message sending, message receiving, a data service, and the like.

The permission setting value may include at least one of a permission value based on which the terminal can determine permissions for a function based on subscription information of the main user, which is set by the main user, and a use condition value for partially restricting permissions depending on at least one condition if a permission for the function based on subscription information of the main user is set as ‘allow’.

Referring to FIG. 2A, it will be assumed that among the multiple users capable of using the terminal, the main user is defined as a first user, and the other sub users are defined as second to N-th users. The memory 130 may store permission values (e.g., a call sending permission, a call receiving permission, a message sending permission, a message receiving permission, a data service permission, and the like) among permission setting values which are set in the second to N-th user's accounts set by the first user. In FIG. 2A, ‘1’ represents ‘allow’ of the permission, while ‘0’ represents ‘restrict’ of the permission.

If a permission of the call sending is set as ‘allow’, the use condition value may include at least one of a call sending time, a call sending location, an amount of the sent call, a recipient of the sent call, and the like.

If a permission of the call receiving is set as ‘allow’, the use condition value may include at least one of a call receiving time, a call receiving location, a sender of the received call, and the like.

If a permission of the message sending is set as ‘allow’, the use condition value may include at least one of a message sending time, a message sending location, an amount of the sent message, a recipient of the sent message, and the like.

If a permission of the message receiving is set as ‘allow’, the use condition value may include at least one of a message receiving time, a message receiving location, a sender of the received message, and the like.

If a permission of the data service is set as ‘allow’, the use condition value may include at least one of a data service time, a data service location, an amount of service data, and the like.

A controller 110 may control operations of the terminal. In accordance with various embodiments of the present disclosure, if the terminal is logged in with a specific sub user's account among the at least one sub user's account (e.g., second to N-th users' accounts), the controller 110 may perform the function based on subscription information of the main user depending on the permission setting value that is set in the specific sub user's account used for the login.

The controller 110 may include a main processor that controls the function of the terminal if the terminal is logged in with an account of the main user, and at least one sub processor that controls the function of the terminal if the terminal is logged in with an account of the at least one sub user.

Referring to FIG. 2B, the controller 110 may include a first processor 110A as a main processor, and second to N-th processors 110B, 110C to 110N as multiple sub processors.

If the terminal is logged in with an account of the main user (e.g., the first user), the first processor 110A may perform the function of the terminal, including the function based on subscription information of the main user.

If the terminal is logged in with an account of a specific sub user (e.g., the second user) among at least one sub user (e.g., the second to N-th users), the first processor 110A may determine, from the memory 130, the permission setting value set in the account of the specific sub user (e.g., the second user), and control a specific sub processor (e.g., the second processor 110B) corresponding to the account of the specific sub user (e.g., the second user) to perform the function based on subscription information of the main user depending on the determined permission setting value.

If the terminal is logged in with an account of the sub user, each of the second to N-th processors 110B to 110N may perform the function of the terminal, including the function based on subscription information of the main user, under control of the first processor 110A.

The first processor 110A may be executed in the background, even if the terminal is logged in with an account of a specific sub user among the at least one sub user (e.g., the second to N-to users).

If the terminal is logged in with an account of a specific user, among an account of the main user (e.g., the first user) and an account of the at least one sub user (e.g., the second to N-th users), the other processors except for the processor corresponding to the specific user's account used for the login may be executed in the background.

If call sending among the functions based on subscription information of the main user is requested while the terminal is logged in with an account of a specific sub user among the at least one sub user, the controller 110 may determine the permission setting value set in the account of the specific sub user. The controller 110 may be configured to perform the call sending if a permission for the call sending is set in the permission setting value as ‘allow’, and to restrict the call sending if the permission for the call sending is set in the permission setting value as ‘restrict’. If the permission for the call sending is set as ‘allow’ based on a permission value of the permission setting value, the controller 110 may partially restrict the permission of the call sending depending on a use condition value of the permission setting value. The use condition value based on the call sending may include at least one of a call sending time, a call sending location, an amount of the sent call, a recipient of the sent call, and the like.

If call receiving among the functions based on subscription information of the main user is requested while the terminal is logged in with an account of a specific sub user among the at least one sub user, the controller 110 may determine the permission setting value set in the account of the specific sub user. The controller 110 may be configured to notify of the call reception if a permission for the call receiving is set in the permission setting value as ‘allow’, and to avoid notifying of the call reception if the permission for the call receiving is set in the permission setting value as ‘restrict’. If the permission for the call receiving is set as ‘allow’ based on a permission value of the permission setting value, the controller 110 may partially restrict the permission to notify of the call reception depending on a use condition value of the permission setting value. The use condition value based on the call receiving may include at least one of a call receiving time, a call receiving location, a sender of the received call, and the like.

If message sending among the functions based on subscription information of the main user is requested while the terminal is logged in with an account of a specific sub user among the at least one sub user, the controller 110 may determine the permission setting value set in the account of the specific sub user. The controller 110 may be configured to perform the message sending if a permission for the message sending is set in the permission setting value as ‘allow’, and to restrict the message sending if the permission for the message sending is set in the permission setting value as ‘restrict’. If the permission for the message sending is set as ‘allow’ based on a permission value of the permission setting value, the controller 110 may partially restrict the permission of the message sending depending on a use condition value of the permission setting value. The use condition value based on the message sending may include at least one of a message sending time, a message sending location, an amount of the sent message, a recipient of the sent message, and the like.

If message receiving among the functions based on subscription information of the main user is requested while the terminal is logged in with an account of a specific sub user among the at least one sub user, the controller 110 may determine the permission setting value set in the account of the specific sub user. The controller 110 may be configured to notify of the message reception if a permission for the message receiving is set in the permission setting value as ‘allow’, and to avoid notifying of the message reception if the permission for the message receiving is set in the permission setting value as ‘restrict’. If the permission for the message receiving is set as ‘allow’ based on a permission value of the permission setting value, the controller 110 may partially restrict the permission to notify of the message reception depending on a use condition value of the permission setting value. The use condition value based on the message receiving may include at least one of a message receiving time, a message receiving location, a sender of the received message, and the like.

If the terminal is logged in with an account of the main user, the controller 110 may be configured to display, as a missed call or a missed message, a call or a message which is received when the terminal is logged in with an account of a sub user whose permission of call receiving or message receiving is restricted.

If data service among the functions based on subscription information of the main user is requested while the terminal is logged in with an account of a specific sub user among the at least one sub user, the controller 110 may determine the permission setting value set in the account of the specific sub user. The controller 110 may be configured to provide the data service if a permission for the data service is set in the permission setting value as ‘allow’, and to restrict provision of the data service if the permission for the data service is set in the permission setting value as ‘restrict’. If the permission for the data service is set as ‘allow’ based on a permission value of the permission setting value, the controller 110 may partially restrict the permission of the data service depending on a use condition value of the permission setting value. The use condition value based on the data service may include at least one of a data service time, a data service location, an amount of service data, and the like.

Referring again to FIG. 1, a camera unit 140 may include a camera sensor for capturing image data and converting the captured optical image signal into an electrical image signal, and a signal processor for converting an analog image signal captured by the camera sensor into digital image data. The camera sensor may be a Charge-Coupled Device (CCD) sensor, a Complementary Metal-Oxide Semiconductor (CMOS) sensor, and the like, and the signal processor may be implemented with a Digital Signal Processor (DSP). The camera sensor and the signal processor may be implemented either integrally or separately.

An image processor 150 performs Image Signal Processing (ISP) to display image signals output from the camera unit 140 on a display 160. The ISP may include gamma correction, interpolation, spatial variation, image effecting, image scaling, Automatic White Balance (AWB), Automatic Exposure (AE), Automatic Focus (AF), and the like. The image processor 150 processes image signals output from the camera unit 140 on a frame basis, and may output the frame image data according to the characteristics and size of the display 160. The image processor 150, which has a video codec, may compress the frame image data displayed on the display 160 and decompress the compressed frame image data into its original frame image data using a coding scheme. The video codec may be a Joint Photographic Experts Group (JPEG) codec, a Moving Picture Expert Group 4 (MPEG4) codec, a Wavelet codec, and the like. The image processor 150 may have an On Screen Display (OSD) function, and may output OSD data according to the size of the displayed screen, under control of the controller 110.

The display 160 may display, on its screen, the image signals output from the image processor 150 and the user data output from the controller 110. A Liquid Crystal Display (LCD) may be used for the display 160. In this case, the display 160 may include an LCD controller, a video memory capable of storing image data, an LCD panel, and the like. When implemented having a touch function, the LCD may serve as an input unit, and the same keys as those on the key input unit 127 may be displayed on the display 160.

If the display 160 is used as a touch screen unit as it is implemented having a touch function, the touch screen unit is comprised of a Touch Screen Panel (TSP) including a plurality of sensor panels, which include a capacitive sensor panel capable of detecting a coarse touch such as a finger touch, and an Electro-Magnetic Resonance (EMR) sensor panel capable of detecting a fine touch such as a pen touch.

A location information receiver 170 receives the current location information of the terminal and transfers it to the controller 110. The location information receiver 170 may be, for example, a Global Positioning System (GPS) receiver.

A SIM card 180, an Integrated Circuit (IC) card for a subscriber identity module, may be inserted into or pulled out from a SIM card socket of the terminal. A subscriber identity module of the SIM card 180 may have a phone number as subscription information of the main user.

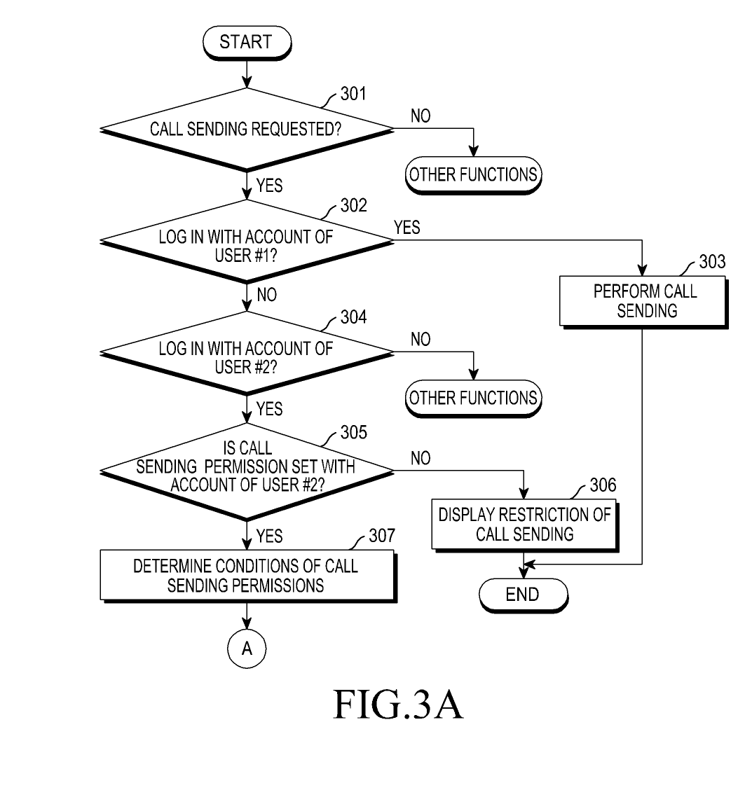

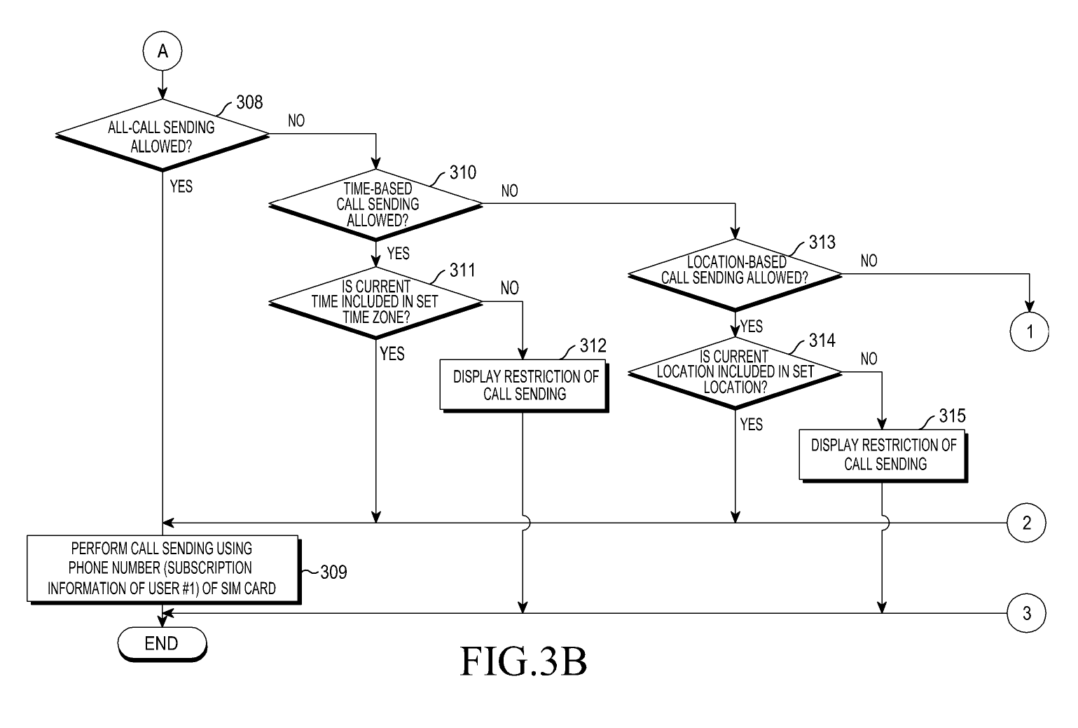

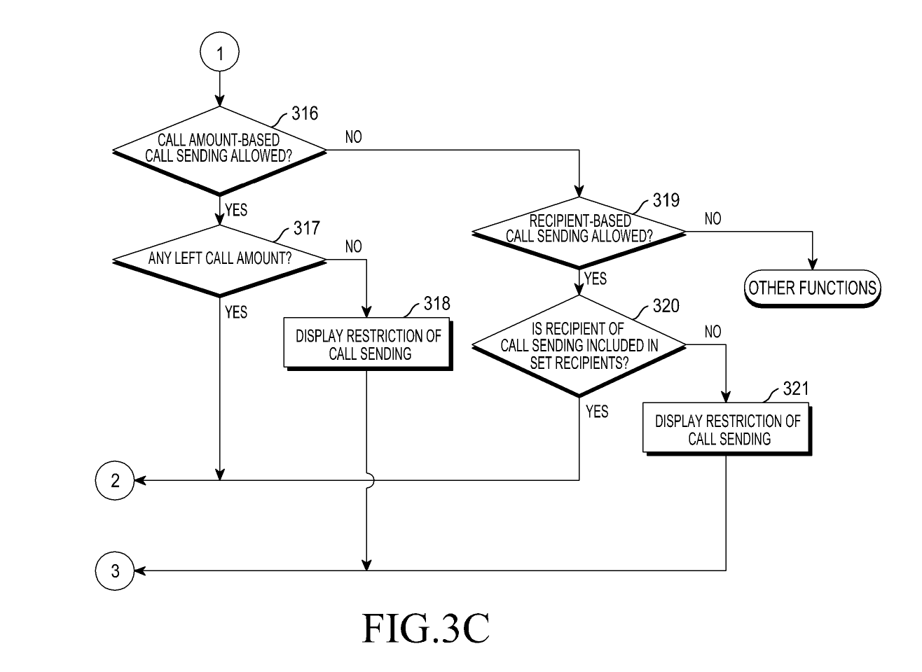

Reference will now be made to FIGS. 3A to 8C to explain an operation of controlling a plurality of sub users to use the function based on subscription information of the main user depending on the preset permissions in the terminal. In accordance with various embodiments of the present disclosure, it will be assumed that a main user having a phone number (or unique number) of a SIM card in the terminal is a first user, and a plurality of other sub users whose permissions are set by the main user are second to N-th users.

FIGS. 3A to 3C are flowcharts illustrating control of a call sending operation in a sub user's account in a terminal according to an embodiment of the present disclosure.

The call sending operation will be described with reference to FIGS. 1, 2A, 2B and 3A to 3C.

Referring to FIGS. 3A to 3C, if call sending is requested in the terminal, the first processor 110A may detect the request in operation 301 and determine in operation 302 an account with which the terminal is logged in. If it is determined in operation 302 that the terminal is logged in with an account of the first user, the first processor 110A may perform call sending in operation 303.

However, if it is determined in operation 302 that the terminal is not logged in with an account of the first user, the first processor 110A may determine in operation 304 whether the terminal is logged in with an account of any one of a plurality of sub users (e.g., the second to N-th users).

If it is determined in operation 304 that the terminal is logged in with an account of the second user among the plurality of sub users, the first processor 110A may determine in operation 305 whether a call sending permission is set with the account of the second user, based on a permission value among the permission setting values set for a plurality of sub users, which are stored in the memory 130.

If it is determined in operation 305 that the call sending permission is not set with the account of the second user, the first processor 110A notifies the second processor 110B that controls the terminal in the account of the second user, of the restriction on the permission for the call sending. In response to the notification, the second processor 110B may restrict the call sending and notify of the restriction on the permission of the call sending in operation 306.

On the other hand, if it is determined in operation 305 that the call sending permission is set with the account of the second user, the first processor 110A may determine a condition of the call sending permission of the second user based on a use condition value among the permission setting values set for the plurality of sub users, which are stored in the memory 130, in operation 307.

After determining the condition of the call sending permission of the second user, if it is determined in operation 308 that ‘all-call sending allowed’ is set, the first processor 110A notifies the second processor 110B that the permission for the call sending is allowed. In response to the notification, the second processor 110B may perform call sending using the phone number (e.g., subscription information of the first user) of the SIM card 180 inserted into the terminal, in operation 309.

However, after determining the condition of the call sending permission of the second user, if it is determined in operation 310 that ‘time-based call sending allowed’ is set, the first processor 110A may determine in operation 311 whether the current time is included in a time zone set in the account of the second user. If the current time is not included in the time zone set in the account of the second user, the first processor 110A notifies the second processor 110B that the permission of the call sending is restricted because the time-based call sending condition is not met. In operation 312, in response to the notification, the second processor 110B may restrict the call sending and notify the user that the permission of the call sending is restricted because the time-based call sending condition is not met.

However, if it is determined in operation 311 that the current time is included in the time zone set in the account of the second user, the first processor 110A notifies the second processor 110B that the permission for the call sending is allowed. In response to the notification, the second processor 110B may perform call sending using the phone number (e.g., subscription information of the first user) of the SIM card 180 inserted into the terminal, in operation 309.

After determining the condition of the call sending permission of the second user, if it is determined in operation 313 that ‘location-based call sending allowed’ is set, the first processor 110A may determine in operation 314 whether the terminal's current location, information about which is received through the location information receiver 170, is included in the location set in the account of the second user. If the current location is not included in the location set in the account of the second user, the first processor 110A notifies the second processor 110B that the permission of the call sending is restricted because the location-based call sending condition is not met. In operation 315, in response to the notification, the second processor 110B may restrict the call sending, and notify the user that the permission of the call sending is restricted because the location-based call sending condition is not met.

However, if it is determined in operation 314 that the current location is included in the location set in the account of the second user, the first processor 110A notifies the second processor 110B that the permission for the call sending is allowed. In response to the notification, the second processor 110B may perform call sending using the phone number (e.g., subscription information of the first user) of the SIM card 180 inserted into the terminal, in operation 309.

After determining the condition of the call sending permission of the second user, if it is determined in operation 316 that ‘call amount-based call sending allowed’ is set, the first processor 110A may determine in operation 317 whether the call amount set in the account of the second user is still left. If the call amount set in the account of the second user is not left, i.e., if the set call amount is used up, the first processor 110A notifies the second processor 110B that the permission of the call sending is restricted due to the lack of the set call amount. In operation 318, in response to the notification, the second processor 110B may restrict the call sending and notify the user that the permission of the call sending is restricted due to the lack of the set call amount.

However, if it is determined in operation 317 that the call amount set in the account of the second user is still left, the first processor 110A notifies the second processor 110B that the permission for the call sending is allowed. In response to the notification, the second processor 110B may perform call sending using the phone number (e.g., subscription information of the first user) of the SIM card 180 inserted into the terminal, in operation 309.

After determining the condition of the call sending permission of the second user, if it is determined in operation 319 that ‘recipient-based call sending allowed’ is set, the first processor 110A may determine in operation 320 whether the recipient, who is a target of the ongoing call sending, is included in the recipient set in the account of the second user. If the recipient of the call sending is not included in the recipient set in the account of the second user, the first processor 110A notifies the second processor 110B that the permission of the call sending is restricted because the recipient-based call sending condition is not met. In operation 321, in response to the notification, the second processor 110B may restrict the call sending, and notify the user that the permission of the call sending is restricted because the recipient-based call sending condition is not met.

However, if it is determined in operation 320 that the recipient of the call sending is included in the recipient set in the account of the second user, the first processor 110A notifies the second processor 110B that the permission for the call sending is allowed. In response to the notification, the second processor 110B may perform call sending using the phone number (e.g., subscription information of the first user) of the SIM card 180 inserted into the terminal, in operation 309.

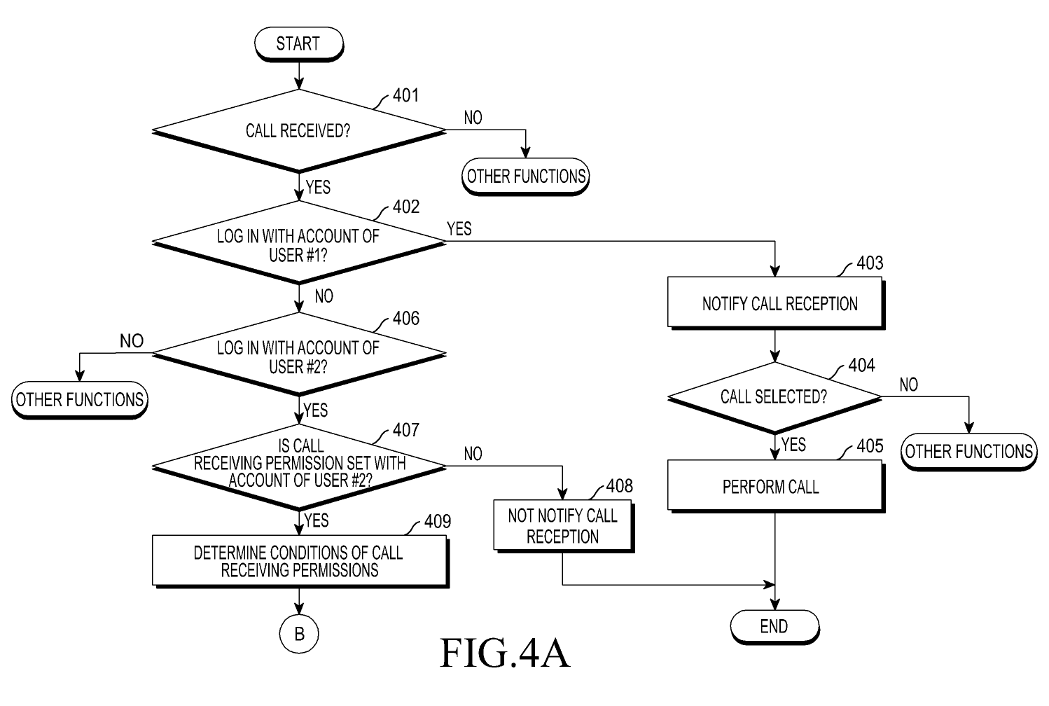

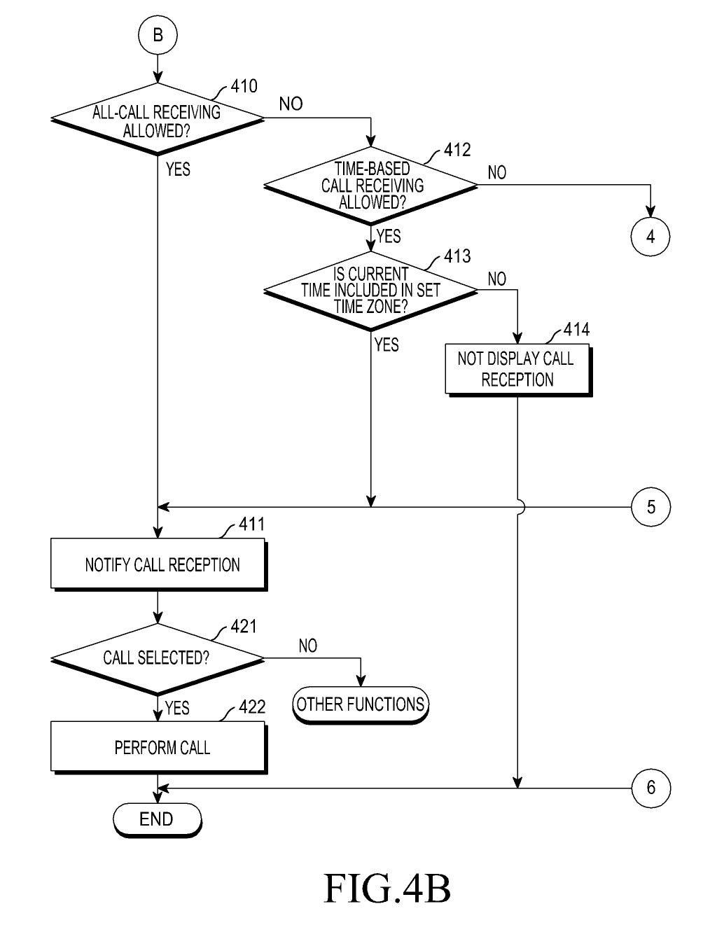

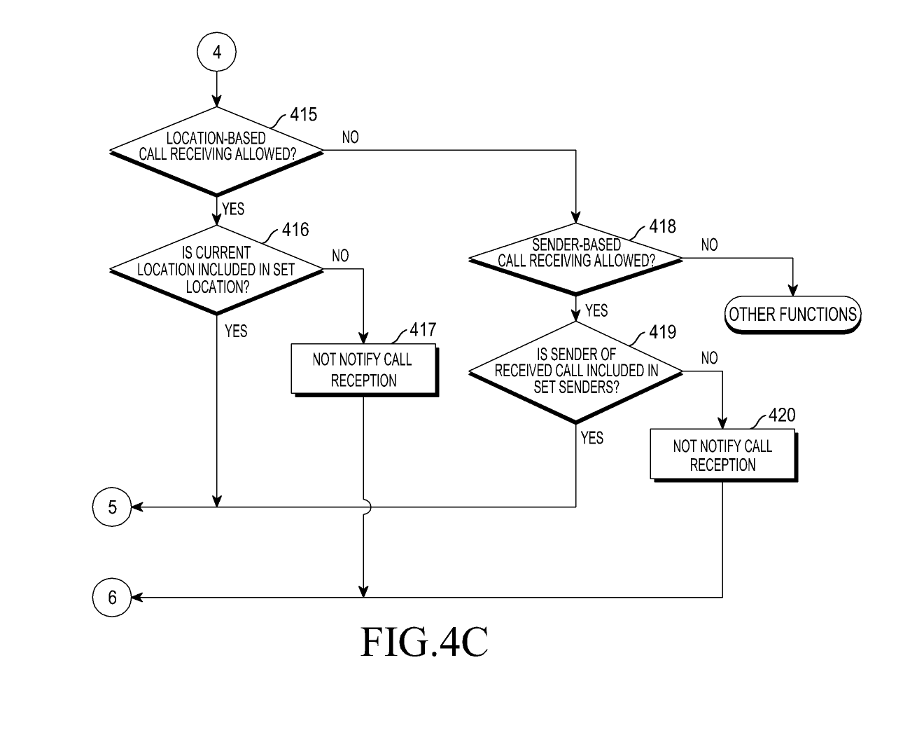

FIGS. 4A to 4C are flowcharts illustrating control of a call receiving operation in a sub user's account in a terminal according to an embodiment of the present disclosure.

The call receiving operation will be described with reference to FIGS. 1, 2A, 2B and 4A to 4C.

Referring to FIGS. 4A to 4C, if a call is received at the terminal, the first processor 110A may detect the call reception in operation 401 and determine in operation 402 an account with which the terminal is logged in. If it is determined in operation 402 that the terminal is logged in with an account of the first user, the first processor 110A may notify of the call reception in operation 403. After notifying of the call reception, the first processor 110A may determine in operation 404 whether the call is selected by the user. If the call is selected in operation 404, the first processor 110A may perform the call in operation 405.

On the other hand, if it is determined in operation 402 that the terminal is not logged in with the account of the first user, the first processor 110A may determine in operation 406 whether the terminal is logged in with an account of any one of a plurality of sub users (e.g., the second to N-th users).

If it is determined in operation 406 that the terminal is logged in with an account of the second user among the plurality of sub users, the first processor 110A may determine in operation 407 whether a call receiving permission is set with the account of the second user, based on a permission value among the permission setting values set for a plurality of sub users, which are stored in the memory 130.

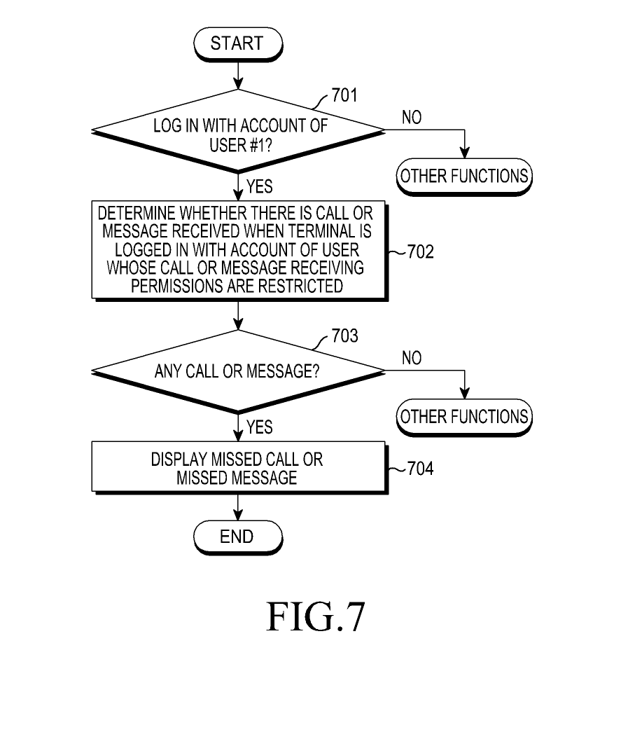

If it is determined in operation 407 that the call receiving permission is not set with the account of the second user, the first processor 110A notifies the second processor 110B that controls the terminal in the account of the second user, of the restriction on the permission for the call receiving. In response to the notification, the second processor 110B may not notify of the call reception in operation 408. The first processor 110A may treat the received call as a missed call, and display the received call as a missed call when the terminal is logged in with the account of the first user. The operation of displaying a received call as a missed call when the terminal is logged in with an account of the first user will be described with reference to FIG. 7.

If it is determined in operation 407 that the call receiving permission is set with the account of the second user, the first processor 110A may determine a condition of the call receiving permission of the second user based on a use condition value among the permission setting values set for the plurality of sub users, which are stored in the memory 130, in operation 409.

After determining the condition of the call receiving permission of the second user, if it is determined in operation 410 that ‘all-call receiving allowed’ is set, the first processor 110A notifies the second processor 110B that the permission for the call receiving is allowed. In response to the notification, the second processor 110B may notify of the call reception in operation 411. As to the notification of the call reception, the second processor 110B may display only the phone number of the sender, display only the name of the sender, display only the notification of the call reception, or display all of them, depending on another use condition value set in the account of the second user.

After the notification of the call reception, the second processor 110B may determine in operation 421 whether the call is selected by the user. If it is determined in operation 421 that the call is selected by the user, the second processor 110B may perform the call in operation 422.

After determining the condition of the call receiving permission of the second user, if it is determined in operation 412 that ‘time-based call receiving allowed’ is set, the first processor 110A may determine in operation 413 whether the current time is included in the time zone set in the account of the second user. If the current time is not included in the time zone set in the account of the second user, the first processor 110A notifies the second processor 110B that the permission of the call receiving is restricted because the time-based call receiving condition is not met. In response to the notification, the second processor 110B may not notify the user of the call reception in operation 414.

If it is determined in operation 413 that the current time is included in the time zone set in the account of the second user, the first processor 110A notifies the second processor 110B that the permission for the call receiving is allowed. In response to the notification, the second processor 110B may perform operations 411 to 422.

After determining the condition of the call receiving permission of the second user, if it is determined in operation 415 that ‘location-based call receiving allowed’ is set, the first processor 110A may determine in operation 416 whether the terminal's current location, information about which is received through the location information receiver 170, is included in the location set in the account of the second user. If the current location is not included in the location set in the account of the second user, the first processor 110A notifies the second processor 110B that the call receiving permission is restricted because the location-based call receiving condition is not met. In response to the notification, the second processor 110B may not notify the user of the call reception in operation 417.

However, if it is determined in operation 416 that the current location is included in the location set in the account of the second user, the first processor 110A notifies the second processor 110B that the permission for the call receiving is allowed. In response to the notification, the second processor 110B may perform operations 411 to 422.

After determining the condition of the call receiving permission of the second user, if it is determined in operation 418 that ‘sender-based call receiving allowed’ is set, the first processor 110A may determine in operation 419 whether a sender who has generated the call, i.e., a sender of the received call, is included in the sender set in the account of the second user. If the sender of the received call is not included in the sender set in the account of the second user, the first processor 110A notifies the second processor 110B that the permission of the call receiving is restricted because the sender-based call receiving condition is not met. In response to the notification, the second processor 110B may not notify the user of the call reception in operation 420.

However, if it is determined in operation 419 that the sender of the received call is included in the sender set in the account of the second user, the first processor 110A notifies the second processor 110B that the permission for the call receiving is allowed. In response to the notification, the second processor 110B may perform operations 411 to 422.

If the terminal is logged in with the account of the first user, the first processor 110A may notify the first user that the notification of the call reception in operation 411 or the call performed through operations 411 to 422 has been performed in the account of the second user.

The first processor 110A may treat the received call, which is not notified to the second user in operations 414, 417 and 420, as a missed call, and notify it to the first user as a missed call if the terminal is logged in with the account of the first user.

The second processor 110B may notify of the call reception, may not notify of the call reception, may display only the sender, or may display only the sender's phone number, depending on another use condition value set in the account of the second user in operations 414, 417 and 420.

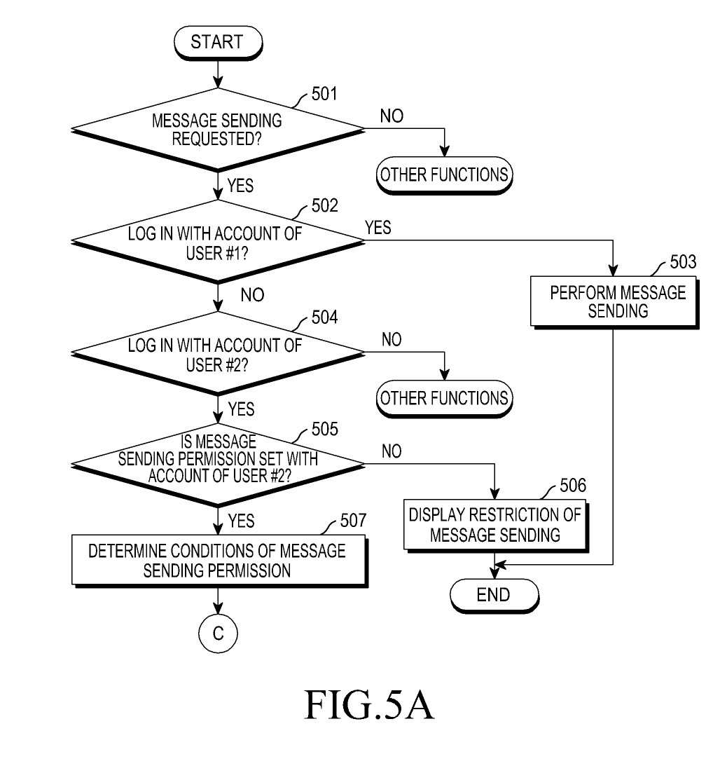

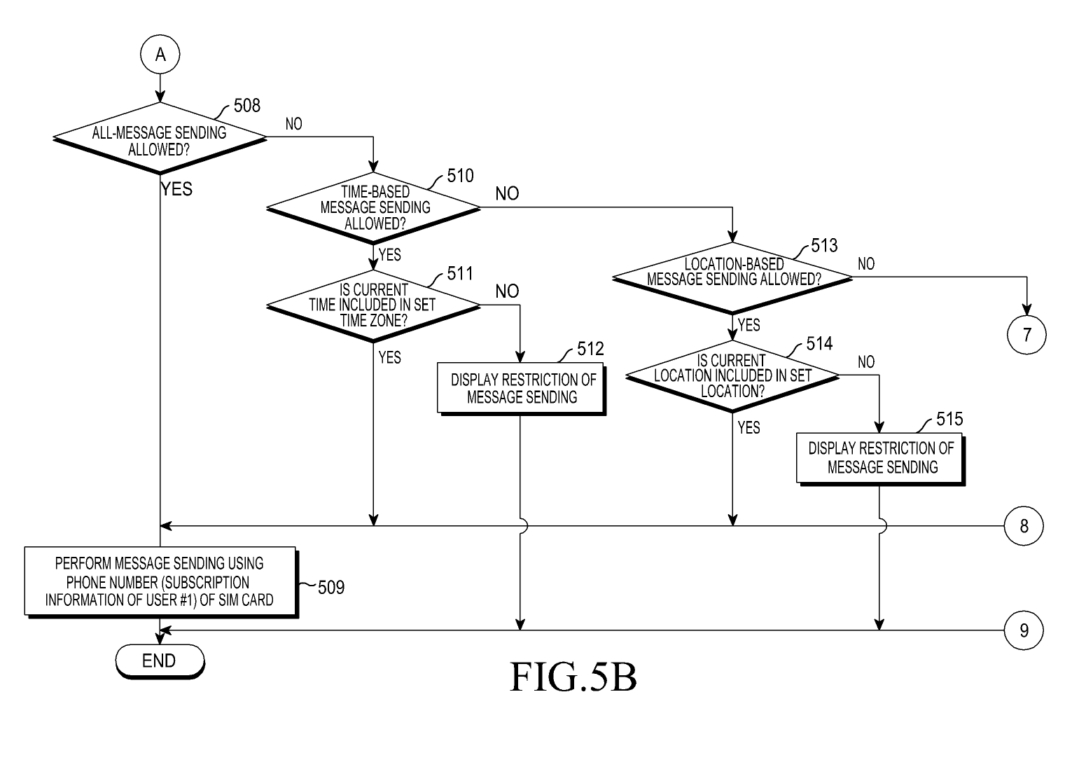

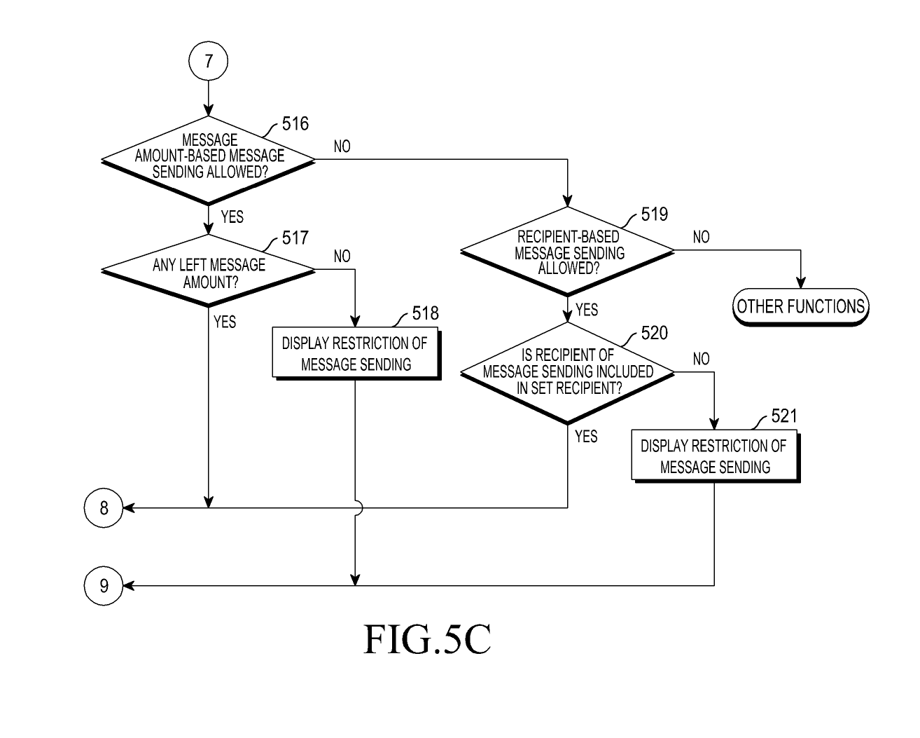

FIGS. 5A to 5C are flowcharts illustrating control of a message sending operation in a sub user's account in a terminal according to an embodiment of the present disclosure.

The message sending operation will be described with reference to FIGS. 1, 2A, 2B and 5A to 5C.

Referring to FIGS. 5A to 5C, if message sending is requested in the terminal, the first processor 110A may detect the request in operation 501 and determine in operation 502 an account with which the terminal is logged in. If it is determined in operation 502 that the terminal is logged in with an account of the first user, the first processor 110A may perform message sending in operation 503.

However, if it is determined in operation 502 that the terminal is not logged in with an account of the first user, the first processor 110A may determine in operation 504 whether the terminal is logged in with an account of any one of a plurality of sub users (e.g., the second to N-th users).

If it is determined in operation 504 that the terminal is logged in with an account of the second user among the plurality of sub users, the first processor 110A may determine in operation 505 whether a message sending permission is set with the account of the second user, based on a permission value among the permission setting values set for a plurality of sub users, which are stored in the memory 130.

If it is determined in operation 505 that the message sending permission is not set with the account of the second user, the first processor 110A notifies the second processor 110B that controls the terminal in the account of the second user, of the restriction on the permission for the message sending. In response to the notification, the second processor 110B may restrict the message sending and notify of the restriction on the permission of the message sending in operation 506.

On the other hand, if it is determined in operation 505 that the message sending permission is set with the account of the second user, the first processor 110A may determine a condition of the message sending permission of the second user based on a use condition value among the permission setting values set for the plurality of sub users, which are stored in the memory 130, in operation 507.

After determining the condition of the message sending permission of the second user, if it is determined in operation 508 that ‘all-message sending allowed’ is set, the first processor 110A notifies the second processor 110B that the permission for the message sending is allowed. In response to the notification, the second processor 110B may perform message sending using the phone number (e.g., subscription information of the first user) of the SIM card 180 inserted into the terminal, in operation 509.

However, after determining the condition of the message sending permission of the second user, if it is determined in operation 510 that ‘time-based message sending allowed’ is set, the first processor 110A may determine in operation 511 whether the current time is included in a time zone set in the account of the second user. If the current time is not included in the time zone set in the account of the second user, the first processor 110A notifies the second processor 110B that the permission of the message sending is restricted because the time-based message sending condition is not met. In operation 512, in response to the notification, the second processor 110B may restrict the message sending and notify the user that the permission of the message sending is restricted because the time-based message sending condition is not met.

However, if it is determined in operation 511 that the current time is included in the time zone set in the account of the second user, the first processor 110A notifies the second processor 110B that the permission for the message sending is allowed. In response to the notification, the second processor 110B may perform message sending using the phone number (e.g., subscription information of the first user) of the SIM card 180 inserted into the terminal, in operation 509.

After determining the condition of the message sending permission of the second user, if it is determined in operation 513 that ‘location-based message sending allowed’ is set, the first processor 110A may determine in operation 514 whether the terminal's current location, information about which is received through the location information receiver 170, is included in the location set in the account of the second user. If the current location is not included in the location set in the account of the second user, the first processor 110A notifies the second processor 110B that the permission of the message sending is restricted because the location-based message sending condition is not met. In operation 515, in response to the notification, the second processor 110B may restrict the message sending, and notify the user that the permission of the message sending is restricted because the location-based message sending condition is not met.

However, if it is determined in operation 514 that the current location is included in the location set in the account of the second user, the first processor 110A notifies the second processor 110B that the permission for the message sending is allowed. In response to the notification, the second processor 110B may perform message sending using the phone number (e.g., subscription information of the first user) of the SIM card 180 inserted into the terminal, in operation 509.

After determining the condition of the message sending permission of the second user, if it is determined in operation 516 that ‘message amount-based message sending allowed’ is set, the first processor 110A may determine in operation 517 whether the message amount set in the account of the second user is still left. If the message amount set in the account of the second user is not left, i.e., if the set message amount is used up, the first processor 110A notifies the second processor 110B that the permission of the message sending is restricted due to the lack of the set message amount. In operation 518, in response to the notification, the second processor 110B may restrict the message sending and notify the user that the permission of the message sending is restricted due to the lack of the set message amount.

However, if it is determined in operation 517 that the message amount set in the account of the second user is still left, the first processor 110A notifies the second processor 110B that the permission for the message sending is allowed. In response to the notification, the second processor 110B may perform message sending using the phone number (e.g., subscription information of the first user) of the SIM card 180 inserted into the terminal, in operation 509.

After determining the condition of the message sending permission of the second user, if it is determined in operation 519 that ‘recipient-based message sending allowed’ is set, the first processor 110A may determine in operation 520 whether the recipient, who is a target of the ongoing message sending, is included in the recipient set in the account of the second user. If the recipient of the message sending is not included in the recipient set in the account of the second user, the first processor 110A notifies the second processor 110B that the permission of the message sending is restricted because the recipient-based message sending condition is not met. In operation 521, in response to the notification, the second processor 110B may restrict the message sending, and notify the user that the permission of the message sending is restricted because the recipient-based message sending condition is not met.

However, if it is determined in operation 520 that the recipient of the message sending is included in the recipient set in the account of the second user, the first processor 110A notifies the second processor 110B that the permission for the message sending is allowed. In response to the notification, the second processor 110B may perform message sending using the phone number (e.g., subscription information of the first user) of the SIM card 180 inserted into the terminal, in operation 509.

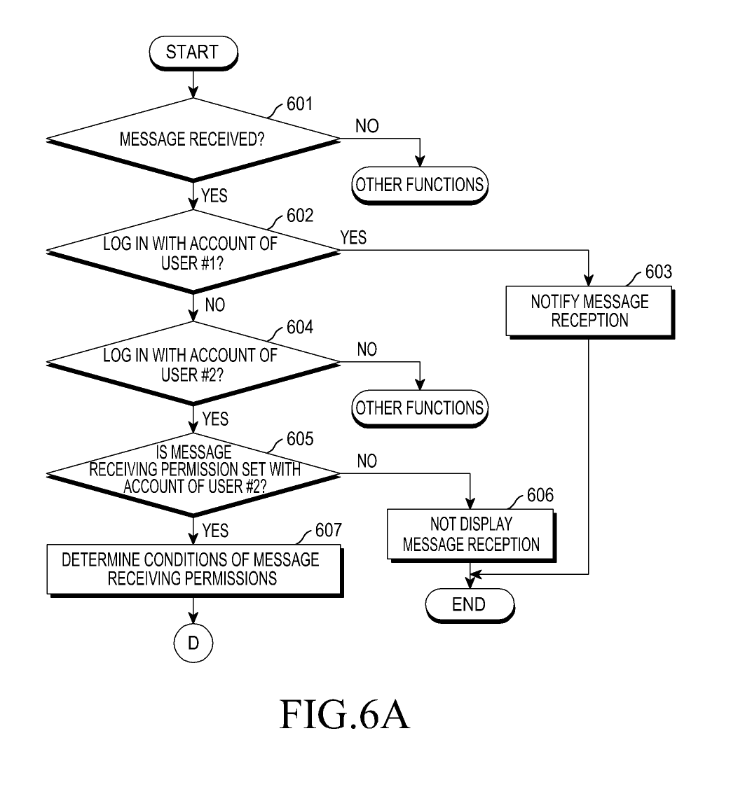

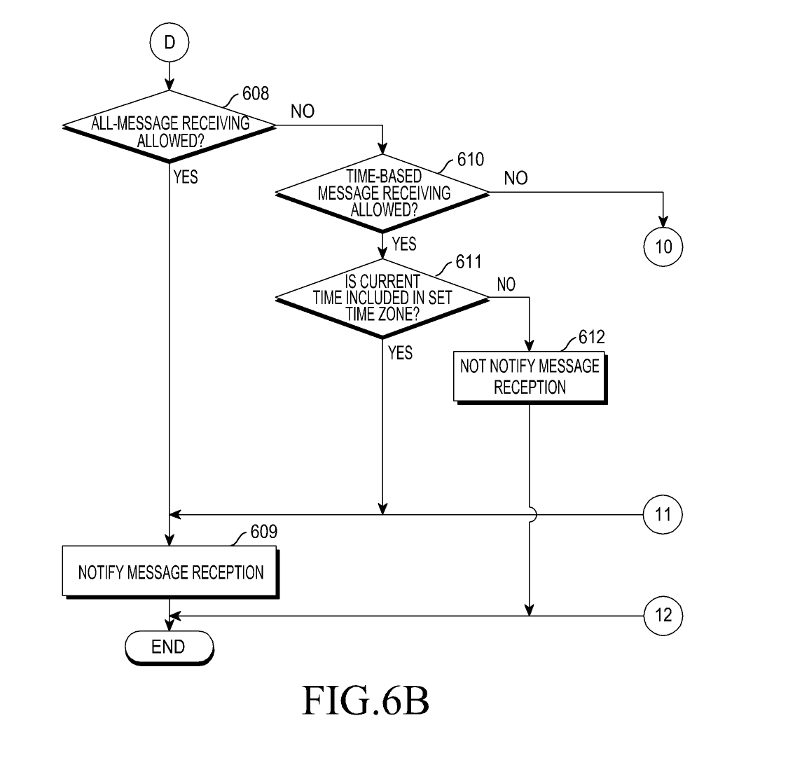

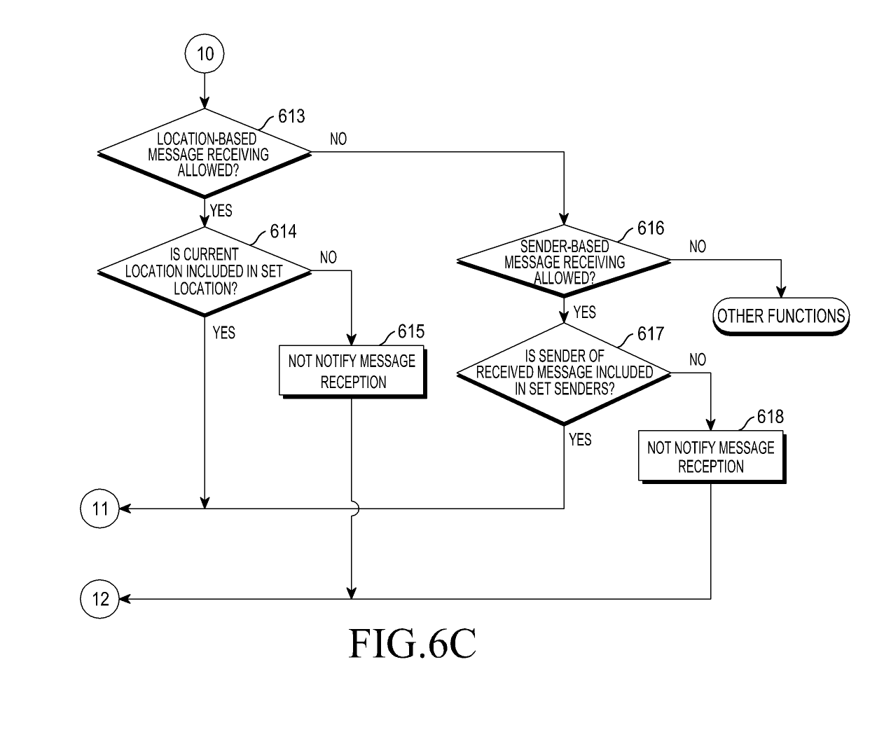

FIGS. 6A to 6C are flowcharts illustrating control of a message receiving operation in a sub user's account in a terminal according to an embodiment of the present disclosure.

The message receiving operation will be described with reference to FIGS. 1, 2A, 2B and 6A to 6C.

Referring to FIGS. 6A to 6C, if a message is received at the terminal, the first processor 110A may detect the message reception in operation 601 and determine in operation 602 an account with which the terminal is logged in. If it is determined in operation 602 that the terminal is logged in with an account of the first user, the first processor 110A may notify of the message reception in operation 603.

On the other hand, if it is determined in operation 602 that the terminal is not logged in with the account of the first user, the first processor 110A may determine in operation 604 whether the terminal is logged in with an account of any one of a plurality of sub users (e.g., the second to N-th users).

If it is determined in operation 604 that the terminal is logged in with an account of the second user among the plurality of sub users, the first processor 110A may determine in operation 605 whether a message receiving permission is set with the account of the second user, based on a permission value among the permission setting values set for a plurality of sub users, which are stored in the memory 130.

If it is determined in operation 605 that the message receiving permission is not set with the account of the second user, the first processor 110A notifies the second processor 110B that controls the terminal in the account of the second user, of the restriction on the permission for the message receiving. In response to the notification, the second processor 110B may not notify of the message reception in operation 606. The first processor 110A may treat the received message as a missed message, and display the received message as a missed message when the terminal is logged in with the account of the first user. The operation of displaying a received message as a missed message when the terminal is logged in with an account of the first user will be described below with reference to FIG. 7.

If it is determined in operation 605 that the message receiving permission is set with the account of the second user, the first processor 110A may determine a condition of the message receiving permission of the second user based on a use condition value among the permission setting values set for the plurality of sub users, which are stored in the memory 130, in operation 607.

After determining the condition of the message receiving permission of the second user, if it is determined in operation 608 that ‘all-message receiving allowed’ is set, the first processor 110A notifies the second processor 110B that the permission for the message receiving is allowed. In response to the notification, the second processor 110B may notify of the message reception in operation 609. As to the notification of the message reception, the second processor 110B may display only the phone number of the sender, display only the name of the sender, display only the notification of the message reception, or display all of them, depending on another use condition value set in the account of the second user.

After determining the condition of the message receiving permission of the second user, if it is determined in operation 610 that ‘time-based message receiving allowed’ is set, the first processor 110A may determine in operation 611 whether the current time is included in the time zone set in the account of the second user. If the current time is not included in the time zone set in the account of the second user, the first processor 110A notifies the second processor 110B that the permission of the message receiving is restricted because the time-based message receiving condition is not met. In response to the notification, the second processor 110B may not notify the user of the message reception in operation 612.

If it is determined in operation 611 that the current time is included in the time zone set in the account of the second user, the first processor 110A notifies the second processor 110B that the permission for the message receiving is allowed. In response to the notification, the second processor 110B may notify of the message reception in operation 609.

After determining the condition of the message receiving permission of the second user, if it is determined in operation 613 that ‘location-based message receiving allowed’ is set, the first processor 110A may determine in operation 614 whether the terminal's current location, information about which is received through the location information receiver 170, is included in the location set in the account of the second user. If the current location is not included in the location set in the account of the second user, the first processor 110A notifies the second processor 110B that the message receiving permission is restricted because the location-based message receiving condition is not met. In response to the notification, the second processor 110B may not notify the user of the message reception in operation 615.

However, if it is determined in operation 614 that the current location is included in the location set in the account of the second user, the first processor 110A notifies the second processor 110B that the permission for the message receiving is allowed. In response to the notification, the second processor 110B may notify of the message reception in operation 609.

After determining the condition of the message receiving permission of the second user, if it is determined in operation 616 that ‘sender-based message receiving allowed’ is set, the first processor 110A may determine in operation 617 whether a sender who has generated the message, i.e., a sender of the received message, is included in the sender set in the account of the second user. If the sender of the received message is not included in the sender set in the account of the second user, the first processor 110A notifies the second processor 110B that the permission of the message receiving is restricted because the sender-based message receiving condition is not met. In response to the notification, the second processor 110B may not notify the user of the message reception in operation 618.

However, if it is determined in operation 617 that the sender of the received message is included in the sender set in the account of the second user, the first processor 110A notifies the second processor 110B that the permission for the message receiving is allowed. In response to the notification, the second processor 110B may notify of the message reception in operation 609.

If the terminal is logged in with the account of the first user, the first processor 110A may notify the first user that the notification of the message reception in operation 609 has been performed in the account of the second user.

The first processor 110A may treat the received message, which is not notified to the second user in operations 612, 615 and 618, as a missed message, and notify it to the first user as a missed message if the terminal is logged in with the account of the first user.

The second processor 110B may notify of the message reception, may not notify of the message reception, may display only the message sender, or may display only the message sender's phone number, depending on another use condition value set in the account of the second user in operations 612, 615 and 618.

FIG. 7 is a flowchart illustrating an operation of notifying of the presence of a call or a message received in an account of a sub user whose permission is restricted, in a main user's account in a terminal according to an embodiment of the present disclosure.

This operation will be described with reference to FIGS. 1, 2A, 2B and 7.

Referring to FIG. 7, the first processor 110A determines in operation 701 whether the terminal is logged in with an account of the first user. If it is determined in operation 701 that the terminal is logged in with the account of the first user, the first processor 110A may determine in operation 702 whether there is a received call or a received message, when the terminal is logged in with an account of a specific user whose permission of call receiving or message receiving is restricted, among the second to N-th users.

If it is determined in operation 703 that there is a received call or a received message, restriction on the permission of which is not notified in the account of the specific user, the first processor 110A may display the call or the message as a missed call or a missed message in operation 704, notifying the first user of the restriction.

In operation 704, the first processor 110A may display the missed call or the missed message together with the type of the account of the specific user whose permission is not notified due to its restriction, and the type of the permission restriction.

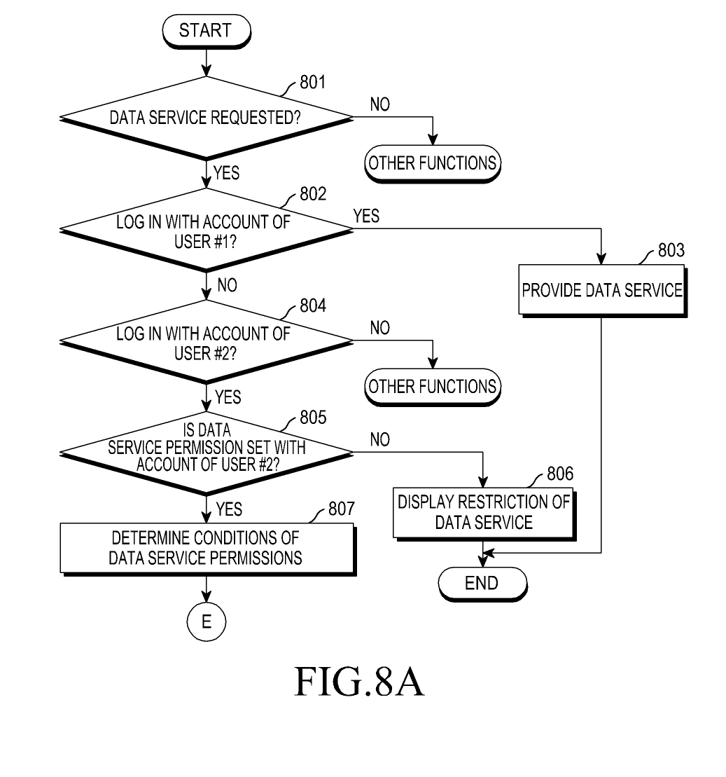

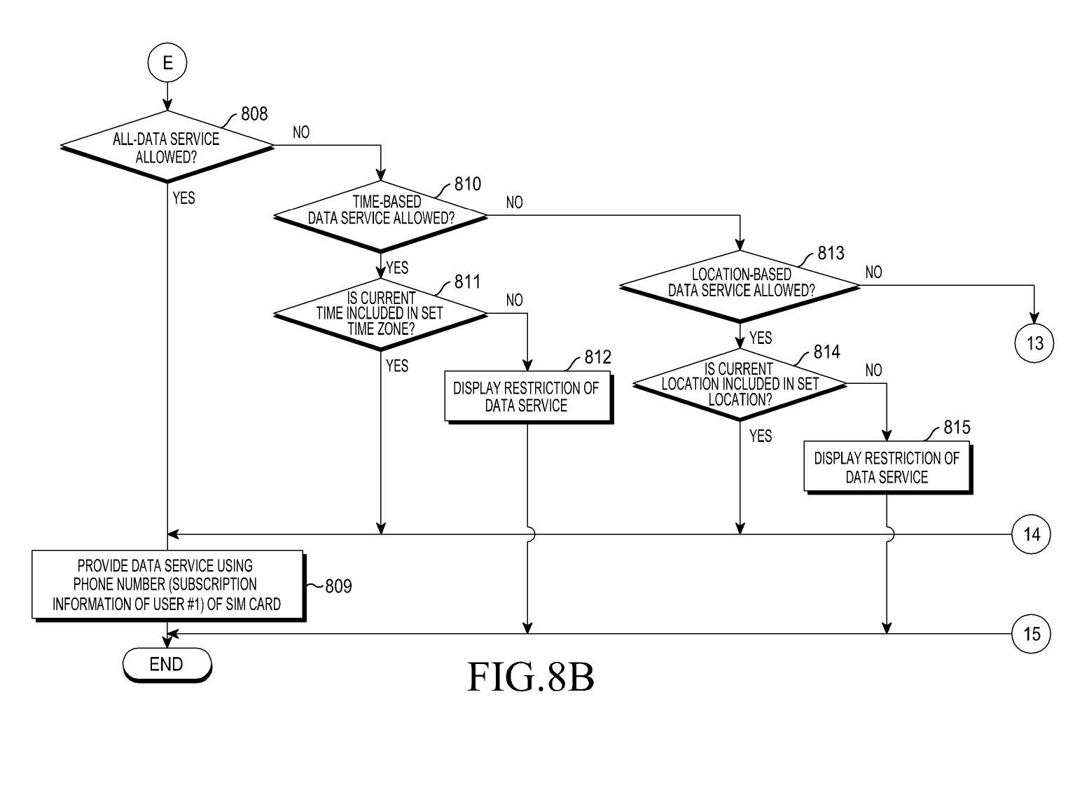

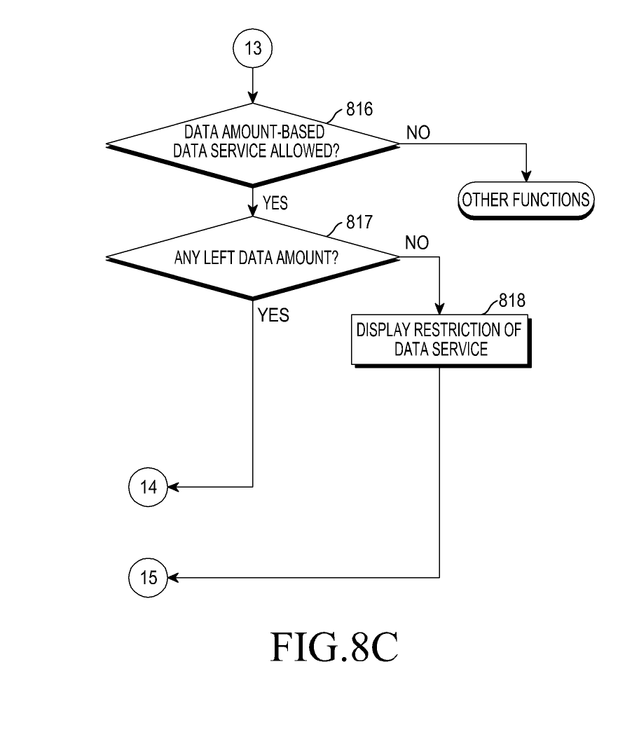

FIGS. 8A to 8C are flowcharts illustrating control of a data service in a sub user's account in a terminal according to an embodiment of the present disclosure.

The control of a data service will be described with reference to FIGS. 1, 2A, 2B and 8A to 8C.

Referring to FIGS. 8A to 8C, if a data service is requested in the terminal, the first processor 110A may detect the request in operation 801 and determine in operation 802 an account with which the terminal is logged in. If it is determined in operation 802 that the terminal is logged in with an account of the first user, the first processor 110A may provide the data service in operation 803.

However, if it is determined in operation 802 that the terminal is not logged in with the account of the first user, the first processor 110A may determine in operation 804 whether the terminal is logged in with an account of any one of a plurality of sub users (e.g., the second to N-th users).

If it is determined in operation 804 that the terminal is logged in with an account of the second user among the plurality of sub users, the first processor 110A may determine in operation 805 whether a data service permission is set with the account of the second user, based on a permission value among the permission setting values set for a plurality of sub users, which are stored in the memory 130.

If it is determined in operation 805 that the data service permission is not set with the account of the second user, the first processor 110A notifies the second processor 110B that controls the terminal in the account of the second user, of the restriction on the permission for the data service. In response to the notification, the second processor 110B may restrict the data service and notify of the restriction on the permission of the data service in operation 806.

If it is determined in operation 805 that a permission of the data service is set with the account of the second user, the first processor 110A may determine a condition of the data service permission of the second user based on a use condition value among the permission setting values set for the plurality of sub users, which are stored in the memory 130, in operation 807.

After determining the condition of the data service permission of the second user, if it is determined in operation 808 that ‘all-data service allowed’ is set, the first processor 110A notifies the second processor 110B that the permission for the data service is allowed. In response to the notification, the second processor 110B may provide the data service using the phone number (e.g., subscription information of the first user) of the SIM card 180 inserted into the terminal, in operation 809.

After determining the condition of the data service permission of the second user, if it is determined in operation 810 that ‘time-based data service allowed’ is set, the first processor 110A may determine in operation 811 whether the current time is included in the time zone set in the account of the second user. If the current time is not included in the time zone set in the account of the second user, the first processor 110A notifies the second processor 110B that the permission of the data service is restricted because the time-based data service condition is not met. In operation 812, in response to the notification, the second processor 110B may restrict the use of the data service and notify the user that the permission of the data service is restricted because the time-based data service condition is not met.

However, if it is determined in operation 811 that the current time is included in the time zone set in the account of the second user, the first processor 110A notifies the second processor 110B that the permission of the data service is allowed. In response to the notification, the second processor 110B may provide the data service using the phone number (e.g., subscription information of the first user) of the SIM card 180 inserted into the terminal, in operation 809.

After determining the condition of the data service permission of the second user, if it is determined in operation 813 that ‘location-based data service allowed’ is set, the first processor 110A may determine in operation 814 whether the terminal's current location, information about which is received through the location information receiver 170, is included in the location set in the account of the second user. If the current location is not included in the location set in the account of the second user, the first processor 110A notifies the second processor 110B that the permission of the data service is restricted because the location-based data service condition is not met. In operation 815, in response to the notification, the second processor 110B may restrict the provision of the data service and notify the user that the permission of the data service is restricted because the location-based data service condition is not met.

However, if it is determined in operation 814 that the current location is included in the location set in the account of the second user, the first processor 110A notifies the second processor 110B that the permission for the data service is allowed. In response to the notification, the second processor 110B may provide the data service using the phone number (e.g., subscription information of the first user) of the SIM card 180 inserted into the terminal, in operation 809.

After determining the condition of the data service permission of the second user, if it is determined in operation 816 that ‘data amount-based data service allowed’ is set, the first processor 110A may determine in operation 817 whether the data amount set in the account of the second user is not left. If the data amount set in the account of the second user is not left, i.e., if the set data amount is used up, the first processor 110A notifies the second processor 110B that the permission of the data service is restricted due to the lack of the set data amount. In operation 818, in response to the notification, the second processor 110B may restrict the provision of the data service and notify the user that the permission of the data service is restricted due to the lack of the set data amount.

However, if it is determined in operation 817 that the data amount set in the account of the second user is still left, the first processor 110A notifies the second processor 110B that the permission of the data service is allowed. In response to the notification, the second processor 110B may provide the data service using the phone number (e.g., subscription information of the first user) of the SIM card 180 inserted into the terminal, in operation 809.

The multi-user permission control method proposed by the present disclosure may be implemented as computer-readable codes in a computer-readable recording medium. The computer-readable recording medium may include any kind of recording device able to store computer-readable data. Examples of the recording medium may include Read Only Memory (ROM), Random Access Memory (RAM), optical disc, magnetic tape, floppy disc, hard disc, non-volatile memory and the like. The computer-readable recording medium may be distributed over computer systems connected over a network, and computer-readable codes may be stored and executed therein in a distributed manner.

As is apparent from the foregoing description, the present disclosure may provide an apparatus and method for controlling multi-user permissions in a terminal according to an embodiment of the present disclosure, making it possible for the terminal supporting multi-user functions and equipped with the telephony function to flexibly provide the functions based on subscription information of the main user to multiple sub users.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for controlling multi-user permissions in a terminal, the apparatus comprising:
a memory configured to store a permission setting value for a function based on subscription information of a main user, which is set in an account of each of at least one sub user, among the main user and the at least one sub user, who may use the terminal; and
a controller configured to, if the terminal is logged in with an account of a specific sub user among the at least one sub user, perform a function based on the subscription information of the main user depending on the permission setting value which is set in the account of the specific sub user, with which the terminal is logged in.

2. The apparatus of claim 1, wherein the permission setting value includes at least one of a permission value based on which the terminal may determine a permission for a function based on the subscription information of the main user, which is set by the main user, and a use condition value for partially restricting a permission depending on at least one condition if a permission for the function based on the subscription information of the main user is set as ‘allow’.

3. The apparatus of claim 1, wherein the function based on the subscription information of the main user is a function using a phone number of a Subscriber Identity Module (SIM) card, and includes at least one of call sending, call receiving, message sending, message receiving, and data service.

4. The apparatus of claim 1, wherein the controller includes a main processor configured to control a function of the terminal when the terminal is logged in with an account of the main user, and at least one sub processor configured to control a function of the terminal when the terminal is logged in with an account of the at least one sub user, and
wherein if the terminal is logged in with an account of a specific sub user among the at least one sub user, the main processor is configured to determine a permission setting value set in the account of the specific sub user, and to control a specific sub processor corresponding to the account of the specific sub user to perform a function based on the subscription information of the main user depending on the determined permission setting value.

5. The apparatus of claim 1, wherein the controller is further configured to:
determine the permission setting value which is set in an account of the specific sub user, if call sending among the functions based on the subscription information of the main user is requested while the terminal is logged in with an account of the specific sub user among the at least one sub user;
perform the call sending, if a permission for the call sending is set in the permission setting value as ‘allow’;
restrict the call sending, if the permission for the call sending is set in the permission setting value as ‘restrict’; and
partially restrict a permission of the call sending depending on a use condition value of the permission setting value of the permission setting value, if a permission for the call sending is set as ‘allow’ based on a permission value of the permission setting value,
wherein the use condition value based on the call sending includes at least one of a call sending time, a call sending location, an amount of the sent call, and a recipient of the sent call.

6. The apparatus of claim 1, wherein the controller is further configured to:
determine the permission setting value which is set in an account of the specific sub user, if call receiving among the functions based on the subscription information of the main user is requested while the terminal is logged in with an account of the specific sub user among the at least one sub user;
notify of the call reception, if a permission for the call receiving is set in the permission setting value as ‘allow’;
avoid notifying of the call reception, if the permission for the call receiving is set in the permission setting value as ‘restrict’; and
partially restrict a permission to notify of the call reception depending on a use condition value of the permission setting value, if a permission for the call receiving is set as ‘allow’ based on a permission value of the permission setting value,
wherein the use condition value based on the call receiving includes at least one of a call receiving time, a call receiving location, and a sender of the received call.

7. The apparatus of claim 1, wherein the controller is further configured to:
determine the permission setting value which is set in an account of the specific sub user, if message sending among the functions based on the subscription information of the main user is requested while the terminal is logged in with an account of the specific sub user among the at least one sub user;
perform the message sending, if a permission for the message sending is set in the permission setting value as ‘allow’;
restrict the message sending, if the permission for the message sending is set in the permission setting value as ‘restrict’; and
partially restrict a permission of the message sending depending on a use condition value of the permission setting value, if a permission for the message sending is set as ‘allow’ based on a permission value of the permission setting value,
wherein the use condition value based on the message sending includes at least one of a message sending time, a message sending location, an amount of the sent message, and a recipient of the sent message.

8. The apparatus of claim 1, wherein the controller is further configured to:
determine the permission setting value which is set in an account of the specific sub user, if message receiving among the functions based on the subscription information of the main user is requested while the terminal is logged in with an account of the specific sub user among the at least one sub user;
notify of the message reception, if a permission for the message receiving is set in the permission setting value as ‘allow’;
avoid notifying of the message reception, if the permission for the message receiving is set in the permission setting value as ‘restrict’; and
partially restrict a permission to notify of the message reception depending on a use condition value of the permission setting value, if a permission for the message receiving is set as ‘allow’ based on a permission value of the permission setting value,
wherein the use condition value based on the message receiving includes at least one of a message receiving time, a message receiving location, and a sender of the received message.

9. The apparatus of claim 1, wherein, if the terminal is logged in with an account of the main user, the controller is further configured to display, as a missed call or a missed message, a call or a message which is received when the terminal is logged in with an account of a sub user whose permission of call receiving or message receiving is restricted.

10. The apparatus of claim 1, wherein the controller is further configured to:
determine the permission setting value which is set in an account of the specific sub user, if a data service among the functions based on the subscription information of the main user is requested while the terminal is logged in with an account of the specific sub user among the at least one sub user;
provide the data service, if a permission for the data service is set in the permission setting value as ‘allow’;
restrict provision of the data service, if the permission for the data service is set in the permission setting value as ‘restrict’; and
partially restrict a permission of the data service depending on a use condition value of the permission setting value, if a permission for the data service is set as ‘allow’ based on a permission value of the permission setting value,
wherein the use condition value based on the data service includes at least one of a data service time, a data service location, and an amount of service data.

11. A method for controlling multi-user permissions in a terminal, the method comprising:
storing a permission setting value for a function based on subscription information of a main user, which is set in an account of each of at least one sub user, among the main user and the at least one sub user, who may use the terminal; and
if the terminal is logged in with an account of a specific sub user among the at least one sub user, performing a function based on the subscription information of the main user depending on the permission setting value which is set in the account of the specific sub user, with which the terminal is logged in.

12. The method of claim 11, wherein the permission setting value includes at least one of a permission value based on which the terminal may determine a permission for a function based on the subscription information of the main user, which is set by the main user, and a use condition value for partially restricting a permission depending on at least one condition if a permission for the function based on the subscription information of the main user is set as ‘allow’.

13. The method of claim 11, wherein the function based on the subscription information of the main user is a function using a phone number of a Subscriber Identity Module (SIM) card, and includes at least one of call sending, call receiving, message sending, message receiving, and data service.

14. The method of claim 11, further comprising:
determining the permission setting value which is set in an account of the specific sub user, if call sending among the functions based on the subscription information of the main user is requested while the terminal is logged in with an account of the specific sub user among the at least one sub user;
performing the call sending, if a permission for the call sending is set in the permission setting value as ‘allow’; and
restricting the call sending, if the permission for the call sending is set in the permission setting value as ‘restrict’,
wherein the performing of the call sending comprises partially restricting a permission of the call sending depending on a use condition value of the permission setting value of the permission setting value, if a permission for the call sending is set as ‘allow’ based on a permission value of the permission setting value, and
wherein the use condition value based on the call sending includes at least one of a call sending time, a call sending location, an amount of the sent call, and a recipient of the sent call.

15. The method of claim 11, further comprising:
determining the permission setting value which is set in an account of the specific sub user, if call receiving among the functions based on the subscription information of the main user is requested while the terminal is logged in with an account of the specific sub user among the at least one sub user;
notifying of the call reception, if a permission for the call receiving is set in the permission setting value as ‘allow’; and
avoiding notifying of the call reception, if the permission for the call receiving is set in the permission setting value as ‘restrict’,
wherein the notifying of the call reception comprises partially restricting a permission to notify of the call reception depending on a use condition value of the permission setting value, if a permission for the call receiving is set as ‘allow’ based on a permission value of the permission setting value, and
wherein the use condition value based on the call receiving includes at least one of a call receiving time, a call receiving location, and a sender of the received call.

16. The method of claim 11, further comprising:
determining the permission setting value which is set in an account of the specific sub user, if message sending among the functions based on the subscription information of the main user is requested while the terminal is logged in with an account of the specific sub user among the at least one sub user;
performing the message sending, if a permission for the message sending is set in the permission setting value as ‘allow’; and
restricting the message sending, if the permission for the message sending is set in the permission setting value as ‘restrict’,
wherein the performing of the message sending comprises partially restricting a permission of the message sending depending on a use condition value of the permission setting value, if a permission for the message sending is set as ‘allow’ based on a permission value of the permission setting value, and
wherein the use condition value based on the message sending includes at least one of a message sending time, a message sending location, an amount of the sent message, and a recipient of the sent message.

17. The method of claim 11, further comprising:
determining the permission setting value which is set in an account of the specific sub user, if message receiving among the functions based on the subscription information of the main user is requested while the terminal is logged in with an account of the specific sub user among the at least one sub user;
notifying of the message reception, if a permission for the message receiving is set in the permission setting value as ‘allow’; and
avoiding notifying of the message reception, if the permission for the message receiving is set in the permission setting value as ‘restrict’,
wherein the notifying of the message reception comprises partially restricting a permission to notify of the message reception depending on a use condition value of the permission setting value, if a permission for the message receiving is set as ‘allow’ based on a permission value of the permission setting value, and
wherein the use condition value based on the message receiving includes at least one of a message receiving time, a message receiving location, and a sender of the received message.

18. The method of claim 11, further comprising:
if the terminal is logged in with an account of the main user, displaying, as a missed call or a missed message, a call or a message which is received when the terminal is logged in with an account of a sub user whose permission of call receiving or message receiving is restricted.

19. The method of claim 11, further comprising:
determining the permission setting value which is set in an account of the specific sub user, if a data service among the functions based on the subscription information of the main user is requested while the terminal is logged in with an account of the specific sub user among the at least one sub user;
providing the data service, if a permission for the data service is set in the permission setting value as ‘allow’; and
restricting provision of the data service, if the permission for the data service is set in the permission setting value as ‘restrict’,
wherein the restricting comprises partially restricting a permission of the data service depending on a use condition value of the permission setting value, if a permission for the data service is set as ‘allow’ based on a permission value of the permission setting value, and
wherein the use condition value based on the data service includes at least one of a data service time, a data service location, and an amount of service data.
